(19) United States
(12) Patent Application Publication
(10) Pub. No.: US 2007/0215530 A1
(43) Pub. Date: Sep. 20, 2007

(54) Method and apparatus for manipulating items on a conveyor

(76) Inventors: Dennis George Ward, Puyallup, WA (US); Christopher William Biddle, Puyallup, WA (US)

Correspondence Address: CENTRAL COAST PATENT AGENCY, INC, 3 HANGAR WAY SUITE D, WATSONVILLE, CA, 95076, US

(21) Appl. No.: 11/376,816

(22) Filed: Mar. 15, 2006

(51) Int. Cl. B07C 5/16

(52) U.S. Cl. 209/645

(57) ABSTRACT

A system for manipulating items for processing includes a conveyor assembly enabled to translate the items in a serial fashion at a height in a first direction, and rotating wheels positioned at a first point along the conveyor, extending above the conveyor height, the wheels rotating such that the top of the wheels moves in the first direction, with the wheels shaped to engage and lift an item from the conveyor momentarily during rotation as the item reaches the first point along the conveyor, and in further rotation place the item back on the conveyor at a second point further along the direction of conveyance.

### BACKGROUND OF THE INVENTION

1. Field of the Invention

The present invention is in the area of equipment and methods for sorting items in various operations, and pertains in one embodiment more particularly to apparatus for weighing individual boards for determination of moisture content.

2. Discussion of the State of the Art

It is well-known that in many commercial operations a relatively large number of items may by moved along by a conveyor, and that different sorts of operations may be necessary to conduct on passing items. One of these operations in many cases is weighing of individual items as the items are moved along a conveyor system.

A good example of the kinds of operations may include weighing is in a lumber mill operation, where individual boards are produced that are of different lengths, different width, and different thickness. In such an operation, where the individual boards have been milled from logs, there is typically a difference in boards that are produced according to what part of a tree that is the source of a particular board. This difference is in moisture content, and dictates at least to some extent downstream operations. For example, boards that come from green heartwood or from sapwood are considerably different in moisture content, and may need to be dried in a different way.

After boards are first produced from raw timber, they are typically stacked in bundles of common cross section, and at least somewhat common length. At some later time it is necessary to determine all the relevant characteristics of each board and to use the information to sort the boards and to schedule downstream operations. This is typically done in the industry by breaking bundles and causing the boards to be placed on one or more conveyors in a manner that each board is separated from its neighbors, and all may be translated in a common direction and be subjected to measuring apparatus and sensors for determining all of the relevant characteristics.

In some cases equipment is available comprising photographic and even video capability such that, as each board passes a particular station the cross-section and the length may be determined for each board. A control system in such a case makes a record for each board. At a downstream point on the same conveyor or conveyors, or on a new conveyor system, the moisture content has to be determined.

The determination of moisture can be done in several different ways, and several systems are available in the art and have been used. For example, load cells have been used for weight sensing in a system in which a vertical translation mechanism moves a carriage vertically to pick up individual pieces of lumber at a particular point along a conveyor system. The carriage rests on load cells, and the weight of the carriage of course is known. As a piece of lumber arrives at the particular point on the conveyor, its presence is sensed, and the translation mechanism is triggered to activate and pick up the piece. As the piece is picked up the weight is noted.

The weight-sensing apparatus and method just described is useful and very accurate, but the system has to operate very frequently because the conveyors move rather rapidly and carry a large number of pieces of lumber in a short time. For example, in some cases, the carriage must translate in less then one second, as boards on the conveyor system passes a point at more than one board per second.

The rapid and frequent operation causes a considerable amount of downtime for adjustment and repair for such a system.

Another way the moisture determination has been done is with dielectric measurement. In such a system electrodes are used to contact individual pieces of lumber at different points, with a known voltage difference between the electrodes, and a determination may be made of moisture content based on dielectric measurement. Unfortunately there are several variables that are difficult to control in the dielectric method, and it has had limited success.

Another system that has been tried is nuclear radiation. This system has proved to be very accurate, but costs and licensing are definite problems.

What is clearly needed therefore is a relatively inexpensive, highly accurate and durable system for determining moisture content in lumber as the lumber proceeds along a conveyor. The unique system and method described below in enabling detail provides exactly those desired characteristics and features.

### SUMMARY OF THE INVENTION

In an embodiment of the invention a system for manipulating items for processing is provided, comprising a conveyor assembly enabled to translate the items in a serial fashion at a height in a first direction, and rotating wheels positioned at a first point along the conveyor, extending above the conveyor height, the wheels rotating such that the top of the wheels moves in the first direction. The wheels are shaped to engage and lift an item momentarily from the conveyor, and in further rotation place the item back on the conveyor at a second point further along the direction of conveyance.

Also in an embodiment there is a floating frame resting on one or more weight sensors and supporting the rotating wheels, and a control subsystem enabled to sense, via the weight sensor or sensors, the combined weight of the floating frame, wheels, and item supported at a point that the item is lifted from the conveyor. In some embodiments the items to be weighed are boards. Also in some embodiments the control subsystem uses the combined weight and known information to determine water content of the board.

In another aspect of the invention a manipulating station for lifting items for processing from a conveyor moving the items in a first direction is provided, comprising rotating wheels positioned at a first point along the conveyor, extending above the conveyor height and rotating such that the top of the wheels moves in the first direction. The wheels are shaped to engage and lift an item momentarily from the conveyor as the item reaches the first point along the conveyor, and in further rotation place the item back on the conveyor at a second point further along the direction of conveyance.

In some embodiments there is also a floating frame resting on one or more weight sensors and supporting the rotating wheels, and a control subsystem enabled to sense, via the weight sensor or sensors, the combined weight of the floating frame, wheels, and item supported at a point that the item is lifted from the conveyor. In some embodiments the items to be weighed are boards, and in some embodiments the control subsystem uses the combined weight and known information to determine water content of the board.

In yet another aspect of the invention a method for lifting items moved along a conveyor in a first direction from the conveyor for processing is provided, comprising the steps of (a) positioning rotating wheels at a first point along the conveyor, the wheels extending above the conveyor height and shaped to engage an item that moves along the conveyor; and

(b) rotating the wheels such that the top of the wheels move in the first direction, and as the item reaches the first point, the wheels engage and lift the item momentarily during rotation, and in further rotation place the item back on the conveyor at a second point further along the direction of conveyance.

In one embodiment the wheels are suspended in a floating frame resting on one or more weight sensors, and a control subsystem is engaged to sense, via the weight sensor or sensors, the combined weight of the floating frame, wheels, and item supported at a point that the item is lifted from the conveyor.

In some embodiments the items to be weighed are boards, and in some embodiments the control subsystem uses the combined weight and known information to determine water content of the boards.

### BRIEF DESCRIPTION OF THE DRAWING FIGURES

FIG. 1a is a side elevation view of a lumber conveyor with a weighing station according to an embodiment of the present invention.

FIG. 1b is a view of the same conveyor shown in FIG. 1a with the weighing station and conveyor somewhat advanced from the position shown in FIG. 1a.

FIG. 1c is a cross-section view of the conveyor of FIG. 1a taken along the section line 1b-1b of FIG. 1a.

FIG. 1d illustrates an embodiment wherein two side-by-side conveyors may be used to handle long boards.

### DETAILED DESCRIPTION OF THE INVENTION

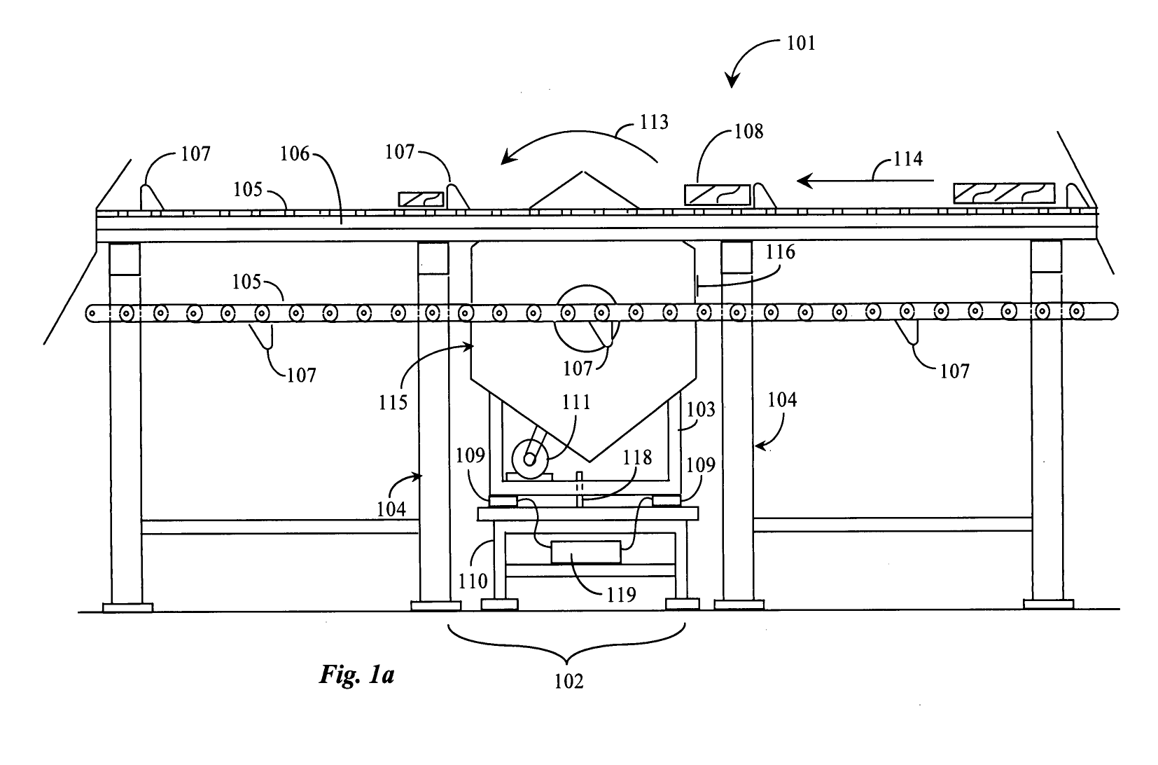

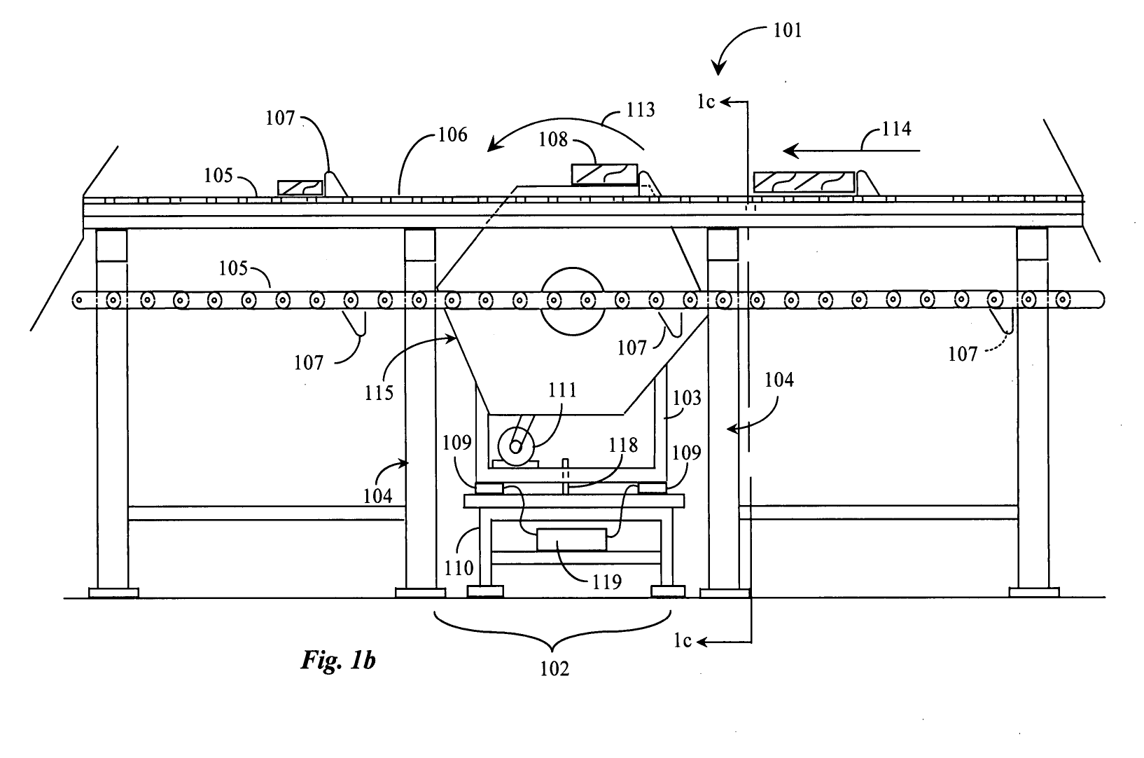

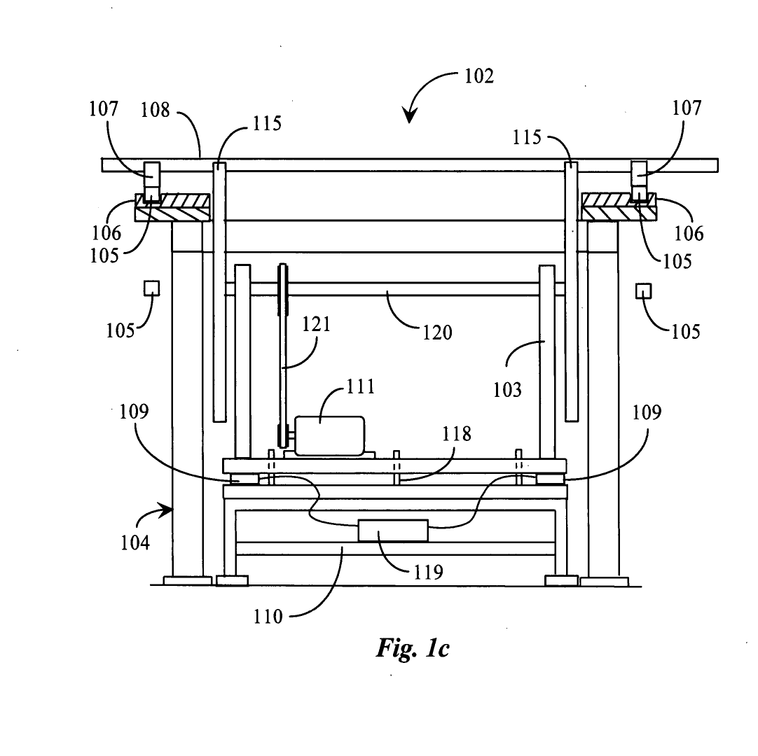

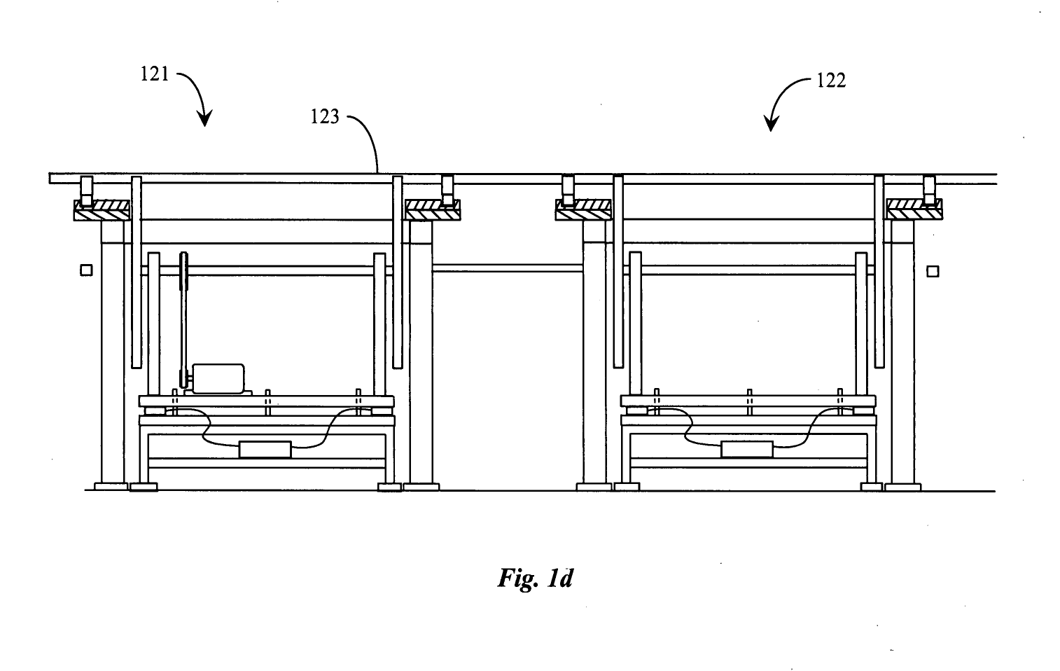

FIG. 1a is a side elevation view of a lumber-carrying conveyor 101 having a weighing station 102 comprising a unique wheel-enabled lifting system having a floating frame 103 for supporting lumber during weighing. FIG. 1b is a view of the same conveyor shown in FIG. 1a with the weighing station and conveyor somewhat advanced from the position shown in FIG. 1a. FIG. 1c is a section view taken along section line 1c-1c of FIG. 1b. All three of these figures should be referenced for a clear understanding of the invention.

Conveyor 101 comprises a frame 104 having at least two conveyor chains 105, with each chain following a track 106 near each edge of the width of the frame in a two-chain conveyor, as seen in FIG. 1c. Each chain 105 has pusher lugs 107 substantially equally spaced along the length and coordinated such that lugs on one chain are directly across from lugs on the other, so a board 108, and other boards at different positions on the conveyor, will be pushed along with the board's length at substantially a right angle to the direction of the conveyor in this example.

In FIG. 1a conveyor 101 is shown truncated in length, and the lower length of chain 105 is in the return path for the conveyor chain. On the top of the conveyor the chains are restricted to and guided in a track 106 as is known in the art and lugs 107 spaced along the chain are projected upward to contact and push boards along the conveyor. In this example the height of track 106 is somewhat less than the vertical width of chain 105, so the upper edge of the chain moves above the track, and boards are carried on the conveyor chain instead of sliding on the track. In other embodiments the boards may be made to slide along the track.

At weighing station 102 floating frame 103 rests on weight sensors 109 and is guided vertically on pins 118 to be able to move vertically a small amount relative to a supporting floor frame 110. An electric motor 111 in this embodiment mounted on the floating frame drives a shaft to drive a set of wheels 115 in the rotary direction indicated by arrow 113, which is generally the same as the conveyor direction indicated by arrow 114. Wheels 115 have, in this example, six flat regions 116. In some embodiments the motor may be mounted on floor frame 110, but that arrangement has been seen to cause problems in measurement due to toque effects of the motor driving the wheels.

As wheels 115 rotate and boards move along the conveyor, each board is caught on a flat region of the wheels and lifted above the conveyor as the wheels rotate. The lifting action, because of the rotary aspect of the wheels and the movement of the conveyor is a steady and gentle action, and the rotation of the wheels is continuous, rather than intermittent. Referring now to FIG. 1b, the conveyor is shown as advanced somewhat over the position seen in FIG. 1a, so board 108 has moved into the region of the weighing station, and wheels 115 have rotated sufficiently that board 108 has been contacted by one of the flat regions of wheels 115 (which is now substantially parallel the conveyor and horizontal) and has been lifted above conveyor 105, so the weight of the board is now supported by wheels 115 carried on floating frame 103, which rests on weight sensors 109. At this position control system 119 takes a weight reading, which is then coordinated with the known dimensions of board 108 (previously measured).

As the conveyor continues to move, and as each board is lifted by wheels 115 above the conveyor, the weight of the lifted board is added to the weight of the floating frame, wheels and drive assembly. Control system 119 is coordinated with the known movement of the conveyor and the wheels to take a weight reading as each flat region on the wheels becomes substantially horizontal. This reading is used with the known weight of the assembly to record the overall weight of the particular board supported. These readings through the control system are also coordinated with readings from a previous station in which the cross section and length of each board is determined, as mentioned above. So the volume of the board may be calculated, the dry weight of such a volume of a board is known, and the difference is the weight of water in the particular board. These readings may then be used to sort the boards for downstream operations, such as drying.

In this manner boards may be continually added to conveyor 101 and their weight determined as a step in determining moisture content, for example. The rotating action of wheels 115 lifting each board as each board passes allows the conveyor to be operated at relatively high speed without damaging any mechanisms or causing downtime for maintenance and repair.

FIG. 1c shows an elevation cross section of the system taken along section line 1c-1c of FIG. 1b. Some elements, such as parts of conveyor 104, are not shown to be able to show better detail of weighing station 102. As seen in FIG. 1c, there are in this embodiment two conveyor chains 105 guided in two tracks 106, the tracks defining an outside width of the conveyor assembly. Floor frame 110 and floating frame 103 guided on pins 118 and resting on weight sensors 109 are all implemented as an assembly between the outside boundaries of conveyor frame 104. Wheels 115 are fixed to a drive shaft 120 carried in bearings through upright portions of floating frame 103. Motor 111 mounted on floating frame 103 drives shaft 120, and hence wheels 115 through belt 121 and pulleys not numbered.

Board 108 in this view rests on wheels 115 and is supported above conveyor chain 105, as is also apparent in FIG. 1b. In this position, as described above, the weight of board 108 is added to the assembly of floating frame 103, the drive mechanism, and the lifting wheels and a reading from sensors 109 can be used with known information to determine the weight added at this point by the supported board.

In some cases boards of longer length than that shown in FIG. 1c may be conveyed, and FIG. 1d illustrates an arrangement in an alternative embodiment for handling longer boards and weighing them as they are conveyed. In this embodiment there are two conveyors 121 and 122 arranged side by side, each with a weighing station at a common point along conveyor length, so a long board 123 may be handles and processed. The manipulations in control are straightforward, as clearly each weighing station supports one-half the weight of board 123.

It will be apparent to the skilled person that for even longer boards three or more such conveyors may be used side-by-side. Alternatively, conveyors may be assembled with more than two lifter wheels for a weighing station. It will also be apparent that the embodiments described above are only exemplary of many alterations that might be made within the spirit and scope of the invention. For example, wheels are not limited to six flat sides as shown, and might take any one of many alternative shapes. There are similarly many ways conveyors may be made, many sorts of conveyor chains, and many other variables in the known-in-the-art elements of the system, outside the patentable subject matter, that might vary in different embodiments of the invention. The invention therefore is entitled to the breadth of the claims that follow.

It should also be apparent to the skilled artisan that the invention in many embodiments is not limited to the items upon which the invention has been illustrated to handle, namely wooden boards. Many other sorts of items that may be moved along a conveyor may be picked up from the conveyor and weighed, or processed in another fashion, by a rotating mechanism according to an embodiment of the present invention.

What is claimed is:

1. A system for manipulating items for processing, comprising:
a conveyor assembly enabled to translate the items in a serial fashion at a height in a first direction; and
rotating wheels positioned at a first point along the conveyor, extending above the conveyor height, the wheels rotating such that the top of the wheels moves in the first direction;
wherein the wheels are shaped to engage and lift an item momentarily from the conveyor, and in further rotation place the item back on the conveyor at a second point further along the direction of conveyance.

2. The system of claim 1 further comprising a floating frame resting on one or more weight sensors and supporting the rotating wheels, and a control subsystem enabled to sense, via the weight sensor or sensors, the combined weight of the floating frame, wheels, and item supported at a point that the item is lifted from the conveyor.

3. The system of claim 2 wherein the items to be weighed are boards.

4. The system of claim 3 wherein the control subsystem uses the combined weight and known information to determine water content of the board.

5. A manipulating station for lifting items for processing from a conveyor moving the items in a first direction, comprising:
rotating wheels sized to be positioned within outer boundaries of the conveyor, extending above the conveyor height and rotating such that the top of the wheels moves in the first direction;
wherein the wheels are shaped to engage and lift an item momentarily from the conveyor as the item reaches a first point along the conveyor, and in further rotation place the item back on the conveyor at a second point further along the direction of conveyance.

6. The station of claim 5 further comprising a floating frame resting on one or more weight sensors and supporting the rotating wheels, and a control subsystem enabled to sense, via the weight sensor or sensors, the combined weight of the floating frame, wheels, and item supported at a point that the item is lifted from the conveyor.

7. The station of claim 6 wherein the items to be weighed are boards.

8. The station of claim 7 wherein the control subsystem uses the combined weight and known information to determine water content of the board.

9. A method for lifting items moved along a conveyor in a first direction from the conveyor for processing, comprising the steps of:
(a) positioning rotating wheels within outer boundaries of the conveyor, the wheels extending above the conveyor height and shaped to engage an item that moves along the conveyor; and
(b) rotating the wheels such that the top of the wheels move in the first direction, and as the item reaches a first point along the conveyor, the wheels engage and lift the item momentarily during rotation, and in further rotation place the item back on the conveyor at a second point further along the direction of conveyance.

10. The method of claim 9 further comprising suspending the wheels on a floating frame resting on one or more weight sensors, and engaging a control subsystem to sense, via the weight sensor or sensors, the combined weight of the floating frame, wheels, and item supported at a point that the item is lifted from the conveyor.

11. The method of claim 10 wherein the items to be weighed are boards.

12. The method of claim 11 wherein the control subsystem uses the combined weight and known information to determine water content of the boards.
